(19) United States
(12) Patent Application Publication
(10) Pub. No.: US 2004/0250035 A1
(43) Pub. Date: Dec. 9, 2004

(54) Method and apparatus for affecting computer system

(76) Inventor: Lee W. Atkinson, Taipei (TW)

Correspondence Address: HEWLETT-PACKARD COMPANY, Intellectual Property Administration, P.O. Box 272400, Fort Collins, CO, 80527-2400, US

(21) Appl. No.: 10/456,114

(22) Filed: Jun. 6, 2003

(51) Int. Cl. G06F 12/14

(52) U.S. Cl. 711/163; 711/202

(57) ABSTRACT

A method and apparatus is disclosed for allowing peripheral devices within a computer system to operate regardless of the computer system's power state. A power saving state may be initiated by the computer system. The computer system may determine the memory mapping of various peripherals that may be coupled to the computer system. Due to the computer system being in a power saving state, portions of the memory may be inaccessible. Peripheral devices that are mapped to the inaccessible portions of the memory may be disabled. Other peripheral devices that are mapped to accessible portions of memory may operate normally despite the computer system being in a power saving mode. Memory control circuitry may be used to enable and disable peripheral devices, where the control circuitry may include various registers. The various registers may include information regarding the memory mapping of the peripheral devices within the computer system.

### BACKGROUND

In the context of computer systems, the term “power management” refers to the ability of a computer system to conserve or otherwise manage the power that it consumes. Many personal computer systems conserve energy by operating in special low-power modes when the user is not actively using the system. Although used in desktop and portable systems alike, these reduced-power modes may particularly benefit laptop and notebook computers by extending the battery life of these systems. Improvements to power management techniques may be desirable.

### BRIEF SUMMARY

A computer system that allows operation of peripheral devices regardless of the computer system's operational state is disclosed. The computer system may include a processor, storage space coupled to the processor, and a plurality of peripheral devices. The computer may be in an operational state may cause at least some of the storage space to be inaccessible. The plurality of peripheral devices may include a first group of peripheral devices that are mapped to inaccessible areas of the storage space and a second group of peripheral devices that are mapped to accessible areas of the storage space. The first group or peripheral devices may be prohibited from operating and the second group of peripheral devices may be allowed to operate regardless of the computer system's operational state and the inaccessibility of the storage space.

### BRIEF DESCRIPTION OF THE DRAWINGS

For a detailed description of the preferred embodiments of the invention, reference will now be made to the accompanying drawings in which:

FIG. 1 shows an exemplary computer systems according to some embodiments;

FIG. 2A shows an exemplary memory management system according to some embodiments;

FIG. 2B shows a peripheral device management apparatus according to some of the embodiments;

FIG. 2C shows a truth table that pertains to logic in FIG. 2B; and

FIG. 3 shows a method of managing peripheral devices according to some of the embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

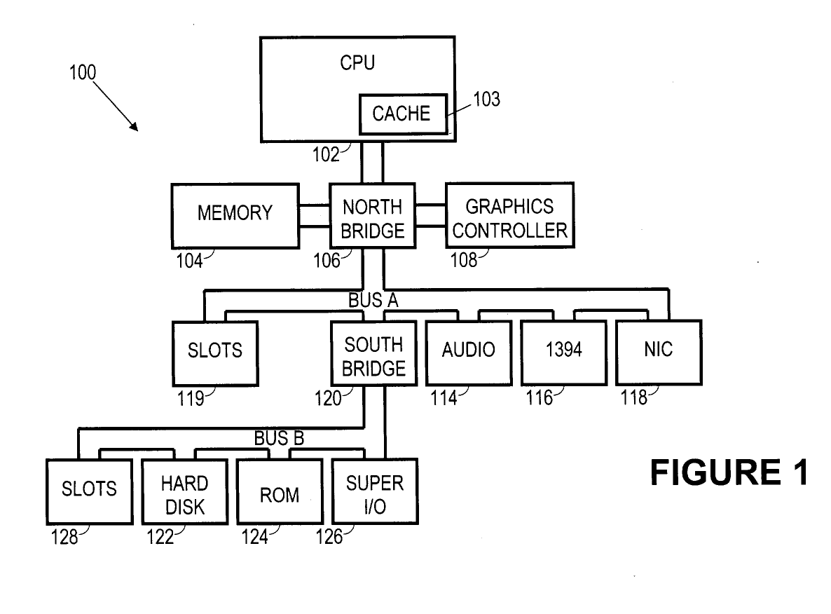

FIG. 1 illustrates an exemplary computer system 100 in accordance with embodiments of the present invention. The computer system 100 may be a portable computer, desktop computer, blade server, or other type of computer system. The computer system of FIG. 1 may include a central processing unit (“CPU”) 102 or processor that may be coupled to a bridge logic device 106 via a CPU bus. The bridge logic device 106 may be referred to as a “North bridge.” The North bridge 106 typically also couples to a main memory array 104 by a memory bus, and may further couple to a graphics controller 108 via an advanced graphics processor (“AGP”) bus. The North bridge 106 may couple together the CPU 102, memory 104, graphics controller 108, and one or more peripheral devices through, for example, a primary expansion bus (“BUS A”) such as a peripheral component interconnect (“PCI”) bus or an enhanced industry standard architecture (“EISA”) bus. Various peripheral devices that operate using the bus protocol of BUS A may reside on this bus, such as an audio device 114, a IEEE 1394 interface device 116, and a network interface card (“NIC”) 118. These components may be integrated onto the motherboard, as suggested by FIG. 1, or they may be plugged into expansion slots 119 that are connected to BUS A.

Secondary expansion buses may be provided in the computer system. If such buses are included, another bridge logic device 120 may be used to couple the primary expansion bus, BUS A, to the secondary expansion bus (shown in FIG. 1 as “BUS B”). This bridge logic 120 may be referred to as a “South bridge.” Various components that operate using the bus protocol of BUS B may reside on this bus, such as a hard disk controller 122, a system ROM 124, and an I/O controller 126. Slots 128 may also be provided for plug-in components that comply with the protocol of BUS B.

Referring still to FIG. 1, computer system 100 may include a cache memory 103 within CPU 102, as indicated by the dashed box. Alternately, the cache memory 103 may be located outside of the CPU 102. In general, cache memory structures may be implemented in a computer system in order to increase the overall speed of the computer in a cost effective manner. While cache memory may be faster than main memory, this increase in speed comes at a price. For example, cache memory 103 that is integrated directly on the CPU 102 may operate at CPU speeds (i.e., the fastest speeds in the computer system), yet by occupying valuable space on the CPU 102, the increase in speed may come at the expense of increased cost of the CPU 102. Consequently, it may be desirable to optimize the size of the cache memory.

Caching involves retaining frequently used data in cache memory so that the next time the CPU 102 needs such data, the data may be retrieved quicker than retrieving the same data from system memory 104. Peripheral devices and programs of the computer system 100 may issue requests for data, but the physical location of the desired data (cache memory, main memory, etc.) may not be known when the request is issued. Thus, peripheral devices and programs may issue logical address requests to specify the location of the desired data, where the logical address request may then be “mapped” by the operating system (“OS”) to a physical data location. Generally, the CPU 102 may examine logical address requests to determine if the data that is being requested exists within the cache memory 103. If a logical address request is directed to data with physical locations in both the cache memory 103 and the main memory 114, then the address request may be satisfied by providing the data from the cache memory 103. If the requested data exists in cache memory as well as main memory, the time that it takes to satisfy a memory request may be decreased by providing the cached version to the requesting entity instead of the version from main memory.

Caching data in this manner may produce several versions of the same piece of data—e.g., one version located in the cache memory and an older version located in the main memory. The cache memory may contain a more recent version of data than main memory, and so it may be desirable to update the main memory to match cache memory. Several schemes exist for ensuring that data in the cache memory and the data in the main memory match. The term “write-through-caching” refers to practice of writing data to the main memory and cache memory simultaneously. In this manner, write-through-caching may ensure that the main memory and cache memory match. The term “write-back-caching” refers to the practice of abstaining from updating the main memory to match the data in cache memory until the data is needed. Write-back-caching may allow better system performance than write-through-caching because main memory may be accessed less frequently. This increase in system performance comes with the risk that data may be lost if it is not updated in main memory. For example, if the computer system inadvertently powers down prior to updating the main memory, then the data in cache memory may be lost.

The term “incoherency ” refers to the situation where the versions of data that exist in the cache memory do not match other versions contained in other storage media, such as main memory. Thus, cache memory may contain valid data, whereas main memory may contain invalid data. In general, incoherency problems may arise in redundant data storage computer systems (such as in caching schemes of traditional computing systems), where the versions of data in the redundant storage locations may not be updated. Since peripheral devices and/or programs need valid data, maintaining coherency between cache memory and other storage media may be important.

The advanced power configuration and power interface (“ACPI”) specification, revision 2.0b, incorporated herein by reference as if reproduced in full below, sets forth industry standards and practice for controlling a computer systems power usage. Under ACPI, the computer system 100 may dynamically be placed into any one of multiple power modes. Depending on the selected power mode, the CPU 102 may implement various graduated processor power states designated as C0 through Cn in the ACPI specification. Some power states, such as the C3 power state, may include reducing the operation of the CPU 102 so that the CPU 102 is substantially inactive. With the CPU 102 inactive, the cache memory 103 may also be inactive and therefore inaccessible which may cause requested data to be fetched from main memory or another data source that may contain invalid data. In order to prevent possible incoherency problems, peripheral devices may be prohibited from accessing stored data while the CPU 102 is in the C3 power state, or any state in which the cache memory 103 is inaccessible. Because some peripheral devices may be inaccessible during the C3 state, the CPU 102 may be limited from entering the low power C3 state, and consequently the computer system 100 may utilize more power.

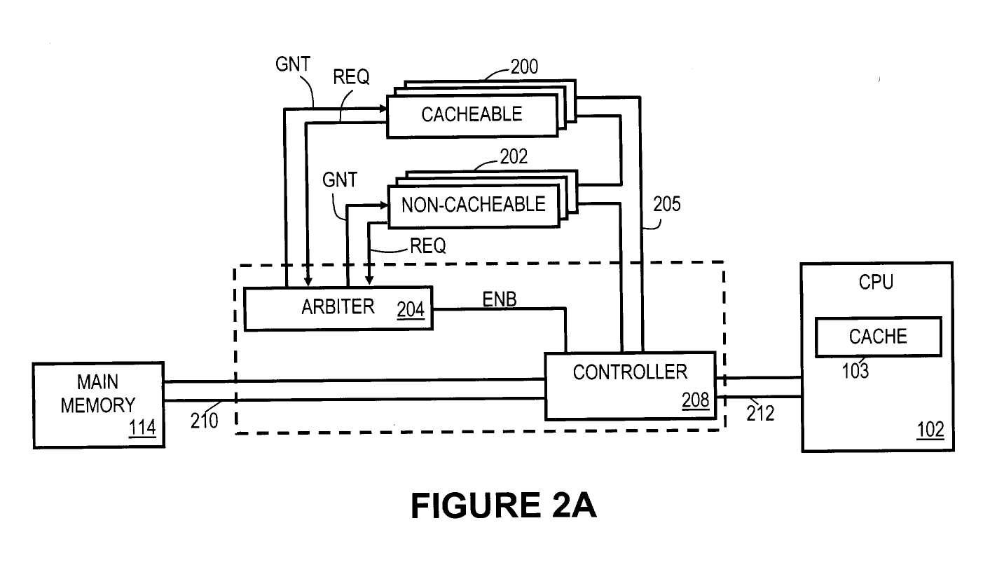

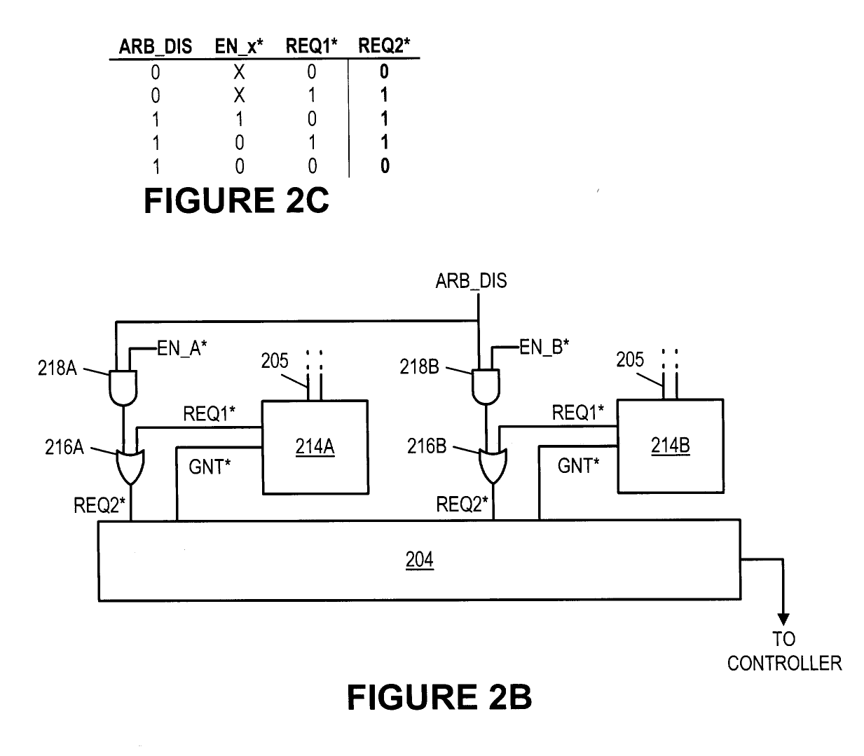

FIG. 2A illustrates an embodiment in which peripheral devices may operate despite the CPU 102 or the cache memory 103 being in a reduced power state. In general, each peripheral device may have a “memory map”, or list of memory locations that the peripheral device may write to. This memory map may include cacheable and non-cacheable memory locations. A first group of peripheral devices 200 may have their memory mapped by, for example, the OS to the cache memory 103. Peripheral devices within group 200 may include, for example, the hard disk 122. A second group of peripheral devices 202 also may have their memory mapped by the OS to non-cacheable memory locations such as in the main memory 114. Peripheral devices within group 202 may include a network interface card or a universal serial bus to name a few.

An arbiter 204 may receive requests for access to bus 205, via the REQ lines, from the peripheral devices 200 and 202 for access to main memory 114, cache memory 103, or another storage device not specifically shown in FIG. 2. The arbiter 204 then may establish which peripheral devices may have access to bus 205 based on each peripheral device's memory map. A grant signal (“GNT”) then may be sent to the peripheral devices that win arbitration and may allow that device to access the bus 205 and perform a memory access. When the arbiter 204 issues a grant to a particular peripheral device, the arbiter 204 may also enable a controller 208 via an ENB line. Note that the controller 208 and the arbiter 204 may be part of the same chipset as indicated by the dashed box.

While the computer system 100 is in a low power state, the controller 208 may be substantially inactive, and therefore an enable signal may reactivate the controller 208. The controller 208 may allow the peripheral device that is accessing bus 205 to access the main memory bus 210 or the processor bus 212. When a particular peripheral device has control of both bus 205 and either memory bus 210 or processor bus 212, without intervention from the CPU 102, it may be referred to as a “bus master”.

In accordance with the ACPI specification, the processor may be inactive so that cache memory 103 may be inaccessible—i.e., processor in the C3 state. Under the current version of the ACPI specification, the OS disables all bus masters prior to entering the C3 state. Disabling bus mastering may prohibit logical memory address requests that are intended for the cache memory 103 from being satisfied by the main memory 114, which may contain invalid data and cause errors.

In some embodiments, the ACPI specification may be amended so that the OS allocates non-cacheable memory locations to bus masters, and the task of disabling some bus masters prior to entering the C3 state may be omitted. The memory map may be configured to indicate whether a particular memory location is non-cacheable, and consequently whether it is assigned to the bus masters. This may be advantageous in that it may be implemented without making a change to the system hardware.

In addition to modifying the ACPI specification, changes to the hardware may be desired in systems that include bus masters that access cacheable memory and bus masters that access non-cacheable memory. In this manner, the arbiter may include multiple registers and logic in order to facilitate bus mastering of certain peripheral devices. For example, because the first group of peripheral devices 200 may have portions of their memory mapped to cache memory 103, bus mastering for these cacheable devices may be disabled, yet bus mastering for the second group of peripheral devices 202, which may not have their memory mapped to cache memory 103, may be enabled.

FIG. 2B illustrates one possible implementation of allowing peripheral devices 214A-B to utilize bus mastering techniques regardless of the computer system's power state. Although the various logic blocks shown in FIG. 2B is shown separate from arbiter 204, it should be understood that they may also be incorporated into the arbiter 204. The peripheral devices 214A-B may be either the cacheable or the non-cacheable type shown in FIG. 2A as 200 and 202 respectively. For example, peripheral device 214A may have some of its memory mapped to cacheable memory locations, whereas peripheral device 214B may have none of its memory mapped to non-cacheable memory locations. Reference will now be made to peripheral device 214A, yet it should be understood that peripheral device 214B may have similar connections and functionality as shown in FIG. 2B.

A request line, designated by REQ1* (active low), may be coupled between the peripheral device 214A and an OR gate 216A. The peripheral device 214A may request access to the bus 205 by generating a request on the REQ1* line, where the request may be active low. The arbiter 204 may receive effective requests via the output of the OR gate 216A, indicated as the REQ2* line (active low). When REQ2* is “0” the arbiter 204 is presented with a bus access request and may then grant access of its own accord. The OR gate 216A may have one input coupled to the output of an AND gate 218A. The AND gate 218A may be coupled to the ARB_DIS (as described in the ACPI specification) and a peripheral enable line EN_A* (active low). The peripheral device 214A may obtain access from the arbiter 204 via a grant line, indicated by GNT* (active low). Also, the controller 208 (not specifically shown in FIG. 2B) may be enabled when GNT* is low so that peripheral device 214A may become a bus master.

In order to get access to the bus 205, a peripheral device needs a grant from the arbiter 204. A grant will not be provided unless the effective request line REQ2* is low. Referring to FIG. 2C, a truth table for the logic of FIG. 2B is shown. Bus mastering for each peripheral device may be enabled/disabled by configuring the EN_x* signal, where “x” indicates the particular peripheral device. Thus, as the system goes into the C3 power state the ARB_DIS signal may be set according to the ACPI standard, and individual peripheral devices may still operate as bus masters despite the ARB_DIS being set. For example, upon entering the C3 power state the system may assert the ARB_DIS signal. In this example, peripheral device 214A may not be mapped to cacheable memory, while peripheral device 214B may be mapped to cacheable memory and therefore bus mastering may be desired for peripheral device 214A. Accordingly, bus mastering during the C3 state may be enabled for peripheral device 214A by setting EN_A* low, while bus mastering during the C3 state for may be disabled for peripheral device 214B by setting EN_B* high. In this manner, the ARB_DIS signal may be set according to the ACPI specification, and peripheral devices that are not mapped to cacheable memory may still act as bus masters during the C3 power state.

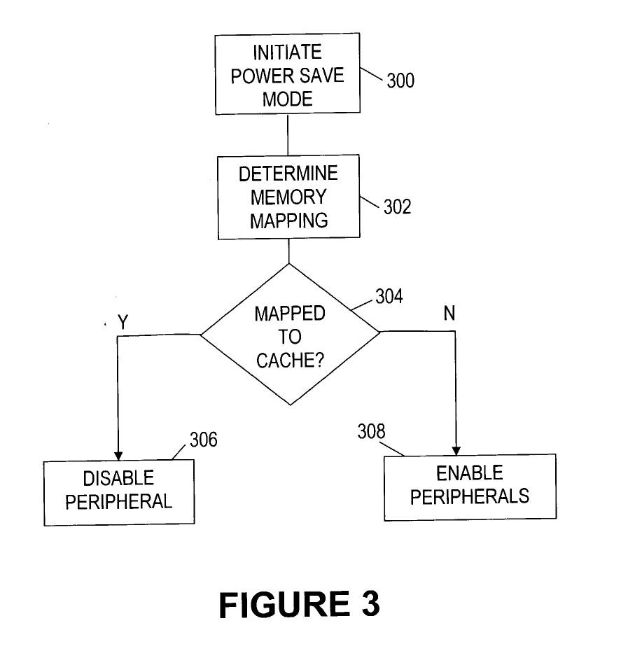

FIG. 3 illustrates one possible method for allowing peripheral devices to operate during low power conditions. The computer system 100 may transition to a power save mode, as depicted by block 300, for example the C3 power state. During the transition, the ARB_DIS signal may be set. In transitioning the computer system 100 to a power save mode, the OS may determine the memory map for each peripheral device in the system as indicated in block 302. If a peripheral device is mapped to an area of memory (such as cache memory 103) that may unavailable during the power save mode, the OS may disable such a cacheable peripheral device as indicated by blocks 304 and 306. Alternatively, if the peripheral device is not mapped to an area of memory that may be unavailable during power saving mode (such as cache memory 103), the OS may enable the non-cacheable peripheral devices as indicated by blocks 304 and 308. For example, the EN_x* bit for each peripheral device may be configured to allow and disallow particular peripheral devices to perform bus mastering. Enabling and disabling peripheral devices may involve setting the EN_x* bit for each peripheral device so that the peripheral devices may or may not have access to bus 205 while the computer system 100 is in a power savings mode. Also, the global ARB_DIS signal may still be configured to deny bus access to all peripheral devices similar to the traditional ACPI C3 power state, yet the actual functionality of the peripheral devices during the C3 state may be indicated by its respective EN_x* signal.

The above discussion is meant to be illustrative of the principles and various embodiments of the present invention. Numerous variations and modifications will become apparent to those skilled in the art once the above disclosure is fully appreciated. For example, although the ACPI specification defines the C3 power state as the state of processor inactivity where the cache memory is unavailable, other specifications may designate other conditions which have the same effect on the computer system. Accordingly, this disclosure is intended to address the situation where peripheral devices that operate independent of unavailable memory ranges may be allowed to operate, despite the unavailability of the memory ranges. It is intended that the following claims be interpreted to embrace all such variations and modifications.

What is claimed is:

1. A computer system, comprising:
a processor;
storage space coupled to the processor, wherein the computer system is in a state that causes at least some of the storage space to be inaccessible;
a first peripheral device that is mapped to inaccessible areas of the storage space; and
a second peripheral device that is mapped to accessible areas of the storage space;
wherein the first peripheral device is prohibited from operating and the second peripheral device is allowed to operate regardless of the computer system's state.

2. The computer system of claim 1, wherein the storage space includes main memory and cache memory, and the cache memory is inaccessible.

3. The computer system of claim 2, wherein the cache memory is inaccessible because the computer system is in a reduced power state.

4. The computer system of claim 2, wherein the first peripheral device is mapped to cache memory and the second peripheral device is mapped to main memory.

5. The computer system of claim 4, wherein the first peripheral device includes peripheral component interconnect (“PCI”) devices.

6. The computer system of claim 1, further comprising a memory controller that is disabled while the computer system is in a power savings state.

7. The computer system of claim 6, wherein the controller is enabled when the second peripheral device is allowed to operate.

8. The computer system of claim 1, including an individual enable signal for the peripheral devices.

9. The computer system of claim 8, wherein the operational state of the computer system is the C3 state of the Advanced Configuration and Power Interface (“ACPI”) specification in which all bus mastering is disabled.

10. The computer system of claim 8, wherein the enable signal prohibits operation of the first device and allows operation of the second device when a global ARB_DIS is selected.

11. The computer system of claim 10, wherein the operational state of the computer system complies with the requirements of the ACPI C3 specification, yet also allows for bus mastering during the C3 state.

12. A method for affecting computer system operation, comprising:
initiating a power mode in which at least a portion of memory becomes inaccessible;
determining the memory mapping of a plurality of peripheral devices;
disabling the peripheral devices that are mapped to a memory location that becomes inaccessible; and
permitting the peripheral devices to access memory if the peripheral devices are mapped to a portion of memory that is accessible during the power mode.

13. The method of claim 12, wherein the memory includes main memory and cache memory, and the cache memory is inaccessible.

14. The method of claim 13, wherein the enabled peripheral devices include PCI devices.

15. The method of claim 12, wherein the computer system's operating system (“OS”) provides memory mapping information.

16. The method of claim 12, wherein initiating the power savings mode further comprises enabling a global disable signal for all peripheral devices and configuring an enable signal such that individual peripheral devices are allowed to act as bus masters regardless of the power savings mode.

17. The method of claim 16, wherein allowing bus mastering complies with ACPI C3 state requirements.

18. The method of claim 12, wherein peripheral devices that are mapped to accessible portions of memory may operate normally despite the computer system being in a power savings mode.

19. The method of claim 18, wherein peripheral devices that are mapped to inaccessible portions of memory are substantially inactive during the power savings mode.

20. A method for affecting computer system operation, comprising:
initiating a power mode in which at least a portion of memory becomes inaccessible; and
determining whether there are peripheral devices mapped to the inaccessible memory, and if no peripheral devices are mapped to the inaccessible memory;
allowing the system to go into the power mode without limiting memory access of any peripheral devices.

21. The method of claim 20, wherein the memory includes main memory and cache memory, and the cache memory is the inaccessible memory.

22. The method of claim 21, wherein the peripheral devices include PCI devices.

23. The method of claim 20, wherein the computer system's operating system (“OS”) determines the memory mapping information.

24. A computer system, comprising:
a processor;
memory coupled to the processor;
a plurality of peripheral devices coupled to the processor; and
means for selecting among the plurality of devices, wherein said selection among the plurality of devices is determined based upon whether the peripheral devices are mapped to inaccessible memory locations.

25. The computer system of claim 24, wherein said means for selecting includes a plurality of registers that aid in determining which peripherals are operational.

26. The computer system of claim 24, wherein the inaccessible memory locations are inaccessible because the computer system is in a power savings mode.

27. The computer system of claim 26, wherein at least some of the peripheral devices are mapped to accessible memory locations and the peripheral devices that are mapped to accessible memory locations operate normally despite the computer system being in a savings power mode.

28. A memory arbiter coupled to at least one peripheral device, wherein the arbiter, dynamically permits the peripheral device to access non-cacheable portions of memory and precludes the peripheral device from accessing the cacheable portions of memory during a predetermined power mode.

29. The arbiter of claim 28, wherein the plurality of peripheral devices include peripheral component interconnect (“PCI”) devices.

30. The arbiter of claim 28, wherein the power mode of the computer system is the C3 state of the Advanced Configuration and Power Interface (“ACPI”) specification in which all bus mastering is disabled.

31. The arbiter of claim 28, further comprising a global disable signal and a local enable signal.

32. The arbiter of claim 31, wherein the global disable signal and local enable signal are configured to reflect the memory mapping of the peripheral devices.

33. The arbiter of claim 32, wherein the arbiter allows or disallows the peripheral device to access memory locations based upon their memory mapping.

34. The arbiter of claim 28, wherein the operational state of the computer system complies with the requirements of the ACPI C3 specification, yet also allows for bus mastering during the C3 state.
